(19) United States
(12) Patent Application Publication
(10) Pub. No.: US 2021/0110260 A1
(43) Pub. Date: Apr. 15, 2021

(54) INFORMATION PROCESSING DEVICE AND INFORMATION PROCESSING METHOD

(71) Applicant: SONY CORPORATION, TOKYO (JP)

(72) Inventors: KAZUKI YOSHIYAMA, KANAGAWA (JP); STEFAN UHLICH, STUTTGART (DE); FABIEN CARDINAUX, STUTTGART (DE)

(21) Appl. No.: 17/050,147

(22) PCT Filed: Mar. 12, 2019
(86) PCT No.: PCT/JP2019/010101

§ 371 Date: Oct. 23, 2020

(30) Foreign Application Priority Data
May 14, 2018 (JP) 2018-093327

(51) Int. Cl. G06N 3/08

(52) U.S. Cl. CPC G06N 3/08

(57) ABSTRACT

To reduce processing load of an operation and to realize learning with higher accuracy. There is provided an information processing device including a learning unit that optimizes parameters that determine a dynamic range by an error back propagation and a stochastic gradient descent in a quantization function of a neural network in which the parameters that determine the dynamic range are arguments. There is provided an information processing method, by a processor, including optimizing parameters that determine a dynamic range by an error back propagation and a stochastic gradient descent in a quantization function of a neural network in which the parameters that determine the dynamic range are arguments.

### FIELD

The present disclosure relates to an information processing device and an information processing method.

### BACKGROUND

Recently, neural networks, which are mathematical models simulating the mechanism of the cerebral nervous system, have attracted attention. In addition, various techniques for reducing processing load of operation in the neural network have been proposed. For example, Non Patent Literature 1 discloses a description related to a quantization function that realizes accurate quantization of intermediate values and weights in learning.

### CITATION LIST

### Non Patent Literature

Non Patent Literature 1: Anonymous authors, “PACT: PARAMETERIZED CLIPPING ACTIVATION FOR QUANTIZED NEURALNETWORKS”, [online], Feb. 16, 2018, Under review as a conference paper at ICLR 2018, [Searched on May 9, 2018], Internet <URL: https://openreview.net/pdf?id=By5ugjyCb>

### SUMMARY

### Technical Problem

However, in the quantization function described in Non Patent Literature 1, consideration for a dynamic range related to quantization is not sufficient. Therefore, it is difficult to optimize the dynamic range with the quantization function described in Non Patent Literature 1.

Therefore, the present disclosure proposes a novel, improved information processing device and information processing method which are capable of reducing processing load of operation and realizing learning with higher accuracy.

### Solution to Problem

According to the present disclosure, an information processing device is provided that includes a learning unit that optimizes parameters that determine a dynamic range by an error back propagation and a stochastic gradient descent in a quantization function of a neural network in which the parameters that determine the dynamic range are arguments.

Moreover, according to the present disclosure, an information processing method, by a processor, is provided that includes optimizing parameters that determine a dynamic range by an error back propagation and a stochastic gradient descent in a quantization function of a neural network in which the parameters that determine the dynamic range are arguments.

### Advantageous Effects of Invention

As described above, according to the present disclosure, it is possible to reduce processing load of operation and to realize learning with higher accuracy.

It is to be noted that the above effect is not necessarily limited, and any of the effects presented in the present description or other effects that can be understood from the present description may be achieved in addition to or in place of the above effect.

### BRIEF DESCRIPTION OF DRAWINGS

FIG. 1 is a diagram for explaining parameter optimization according to an embodiment of the present disclosure.

FIG. 2 is a diagram for explaining the parameter optimization according to the embodiment.

FIG. 3 is a block diagram illustrating a functional configuration example of an information processing device according to the embodiment.

FIG. 4 is a diagram for explaining a learning sequence by a learning unit according to the embodiment.

FIG. 5 is a calculation graph for explaining quantization of a learning parameter using a quantization function according to the embodiment.

FIG. 6 is a diagram for explaining backward propagation related to the quantization function according to the embodiment.

FIG. 7 illustrates a result of a best validation error at the time of weight quantization according to the embodiment.

FIG. 8 are graphs obtained by observing changes in a bit length n when linear quantization of the weight according to the embodiment was performed.

FIG. 9 are graphs obtained by observing changes in a step size δ when linear quantization of the weight according to the embodiment was performed.

FIG. 10 are graphs obtained by observing changes in the bit length n and an upper limit value when power-of-two quantization of a weight where 0 is not permitted according to the embodiment was performed.

FIG. 11 are graphs obtained by observing changes in the bit length n and the upper limit value when power-of-two quantization of a weight where 0 is permitted according to the embodiment was performed.

FIG. 12 illustrates a result of a best validation error in quantization of an intermediate value according to the embodiment.

FIG. 13 are graphs obtained by observing changes in each parameter when quantization of the intermediate value according to the embodiment was performed.

FIG. 14 illustrates a result of a best validation error when quantization of the weight and quantization of the intermediate value according to the embodiment were performed simultaneously.

FIG. 15 are graphs obtained by observing changes in each parameter related to linear quantization of the weight when quantization of the weight and quantization of the intermediate value according to the embodiment were performed simultaneously.

FIG. 16 are graphs obtained by observing changes in each parameter related to linear quantization of the intermediate value when quantization of the weight and quantization of the intermediate value according to the embodiment were performed simultaneously.

FIG. 17 are graphs obtained by observing changes in each parameter related to power-of-two quantization of the weight when quantization of the weight and quantization of the intermediate value according to the embodiment were performed simultaneously.

FIG. 18 are graphs obtained by observing changes in each parameter related to power-of-two quantization of the intermediate value when quantization of the weight and quantization of the intermediate value according to the embodiment were performed simultaneously.

FIG. 19 are figures for explaining an API when performing the linear quantization according to the embodiment.

FIG. 20 are figures for explaining an API when performing the power-of-two quantization according to the embodiment.

FIG. 21 is an example of description of an API when quantization is performed using an identical parameter according to the embodiment.

FIG. 22 is a diagram illustrating a hardware configuration example of the information processing device according to an embodiment of the present disclosure.

FIG. 23 are graphs illustrating an example of quantization performed using a quantization function.

FIG. 24 are graphs illustrating the example of quantization performed using the quantization function.

### DESCRIPTION OF EMBODIMENTS

Hereinafter, a preferred embodiment of the present disclosure will be described in detail with reference to the accompanying drawings. It is to be noted that in the present description and drawings, components having substantially an identical functional configuration are given an identical reference sign, and redundant description thereof is omitted.

It is to be noted that the explanation will be made in the following order.

1. Embodiment

1.1. Overview

1.2. Functional configuration example of information processing device 10

1.3. Details of optimization

1.4. Effects

1.5. API Details

2. Hardware configuration example

3. Summary

### 1. EMBODIMENT

### 1.1. Overview

Recently, learning techniques using neural networks such as deep learning have been widely studied. While the learning technique using the neural network has high accuracy, processing load related to the operation is large, and hence an operation method that effectively reduces the processing load is required.

For this reason, in recent years, many quantization techniques have been proposed in which, for example, parameters such as a weight and a bias are quantized into a few bits to perform operation efficiency improvement and memory saving. Examples of the quantization techniques described above include linear quantization and power quantization.

For example, in the case of linear quantization, an input value x input as float is converted into an int by performing quantization using a quantization function indicated in the following Expression (1), and effects such as operation efficiency improvement and memory saving can be achieved. Expression (1) may be a quantization function used when the quantized value is not permitted to be a negative value (sign=False). In addition, in Expression (1), n represents a bit length and δ represents a step size.

$$y = δ \cdot \{ \begin{matrix}0 & x < 0 \\ ⌊ \frac{x}{δ} + 0.5 ⌋ & 0 \leq x \leq ( {2}^{n} - 1 ) δ \\ {2}^{n} - 1 & ( {2}^{n} - 1 ) δ < x\end{matrix} \qquad ( 1 )$$

In addition, the quantization function given in the following Expression (2) can be used in power-of-two quantization, for example. It is to be noted that Expression (2) may be a quantization function used when the quantized value is not permitted to be a negative value or 0 (sign=False, zero=False). In addition, in Expression (2), n represents a bit length and m represents an upper (lower) limit value.

$$y = \{ \begin{matrix}{2}^{( m - {2}^{π} + 1 )} & x < {2}^{( m - {2}^{n} + 1 )} \\ {2}^{⌊ 0.5 + {log}_{2} x ⌋} & {2}^{( m - {2}^{n} + 1 )} \leq x \leq {2}^{m} \\ {2}^{m} & {2}^{m} < x\end{matrix} \qquad ( 2 )$$

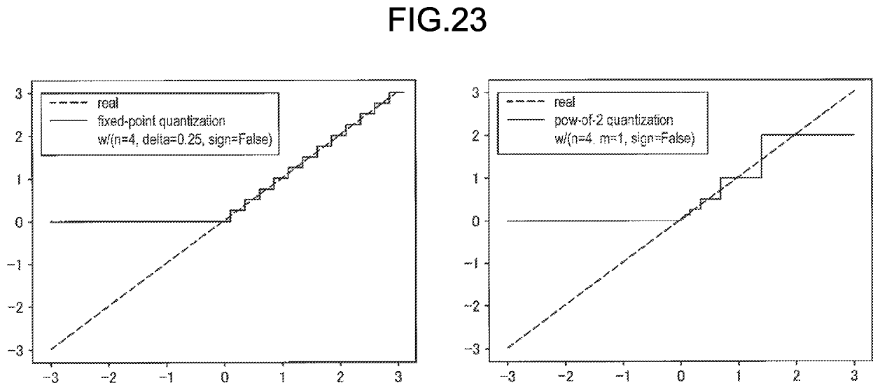

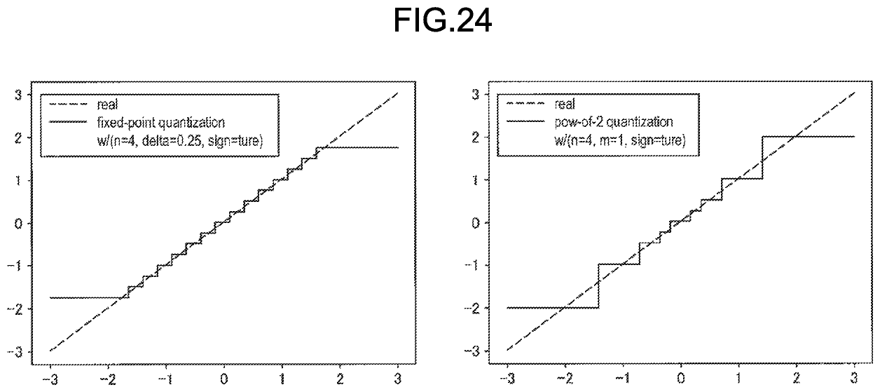

FIGS. 23 and 24 are graphs illustrating an example of quantization performed using the quantization function described above. On the left side of FIG. 23, a solid line indicates the output value when the input value indicated by a dotted line under the condition of (Sign=False, zero=True) is linearly quantized. In this case, the bit length n=4 and the step size δ=0.25.

In addition, on the right side of FIG. 23, a solid line illustrates the output value when the input value illustrated by a dotted line under the condition of (Sign=False, zero=True) is quantized in a power-of-two manner. In this case, the bit length n=4 and an upper limit value m=1.

In addition, on the left side of FIG. 24, a solid line illustrates the output value when the input value illustrated by a dotted line under the condition of (Sign=True, zero=True) is linearly quantized. In this case, the bit length n=4 and the step size δ=0.25.

In addition, on the right side of FIG. 24, a solid line indicates the output value when the input value indicated by a dotted line under the condition of (Sign=True, zero=True) is quantized in a power-of-two manner. In this case, the bit length n=4 and an upper limit value m=1.

As described above, according to quantization techniques such as linear quantization and power quantization, it is possible to realize operation efficiency improvement and memory saving by expressing the input value with a smaller bit length.

In recent years, however, neural networks generally have tens to hundreds of layers. Here, for example, a neural network with 20 layers where the weight coefficient, the intermediate value, and the bias are quantized by power-of-two quantization and trials are made up to the bit length of [2, 8] and the upper limit value of [−16, 16] is assumed. In this case, there are (7×33)×2=462 ways of quantization of the parameter and 7×33=231 ways of quantization of the intermediate value, and thus there are (462×231)\hat{ }20 patterns in total.

Therefore, it has been practically difficult to manually obtain truly optimal hyperparameters.

The technical idea according to the present disclosure was conceived by focusing on the above point, and the technical idea is to make it possible to automatically search for a hyper parameter that realizes highly accurate quantization. For this purpose, an information processing device 10 that realizes an information processing method according to an embodiment of the present disclosure includes a learning unit 110 that optimizes parameters that determine a dynamic range by an error back propagation and a stochastic gradient descent in a quantization function of a neural network in which the parameters that determine the dynamic range are arguments.

Here, the parameters that determine the dynamic range may include at least a bit length at the time of quantization.

The parameters that determine the dynamic range may include various parameters that affect the determination of the dynamic range together with the bit length at the time of quantization. Examples of the parameter include an upper limit value or a lower limit value at the time of power quantization and a step size at the time of linear quantization.

That is, the information processing device 10 according to the present embodiment is capable of optimizing a plurality of parameters that affect the determination of the dynamic range in various quantization functions without depending on a specific quantization technique.

In addition, the information processing device 10 according to the present embodiment may locally or globally optimize the parameters described above on the basis of the setting made by a user, for example.

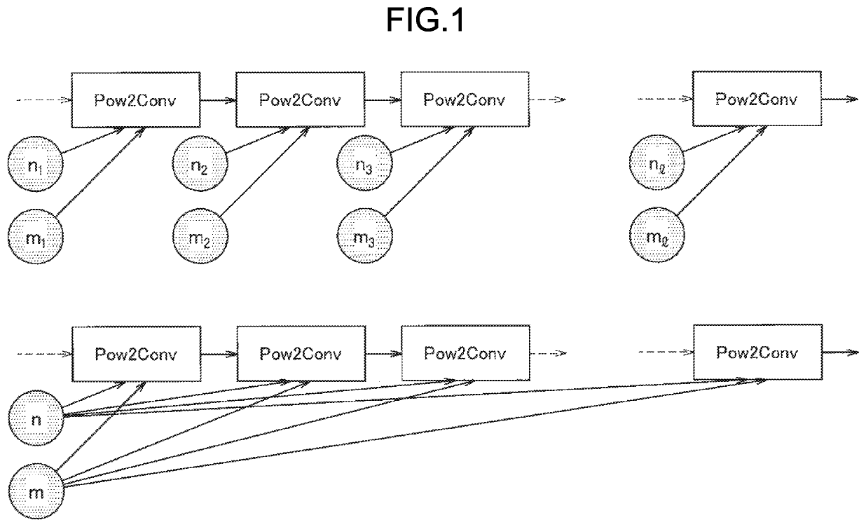

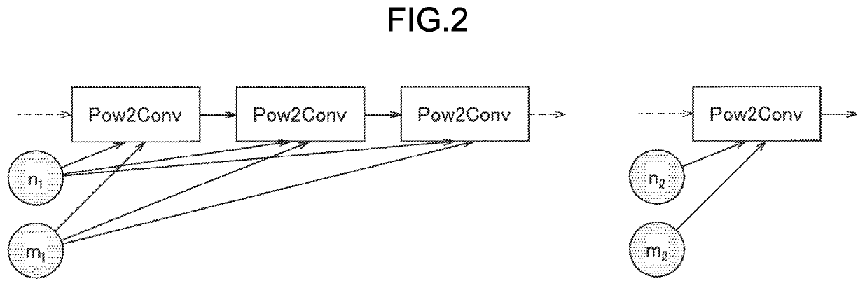

FIGS. 1 and 2 are diagrams for explaining the parameter optimization according to the present embodiment. For example, as illustrated in the upper part of FIG. 1, the information processing device 10 according to the present embodiment may optimize the bit length n and the upper limit value m in the power-of-two quantization for each convolution layer and affine layer.

On the other hand, the information processing device 10 according to the present embodiment may optimize, for a plurality of layers in common, the parameters that determine the dynamic range. The information processing device 10 according to the present embodiment may optimize the bit length n and the upper limit value m in the power-of-two quantization for the entire neural network in common, as illustrated in the lower part of FIG. 1, for example.

In addition, as illustrated in FIG. 2, for example, the information processing device 10 is capable of optimizing the parameter described above for each block including a plurality of layers. The information processing device 10 according to the present embodiment is capable of performing the optimization described above on the basis of the user setting acquired by an application programming interface (API) described later.

Hereinafter, the function described above of the information processing device 10 according to the present embodiment will be described in detail.

### 1.2. Functional Configuration Example of Information Processing Device 10

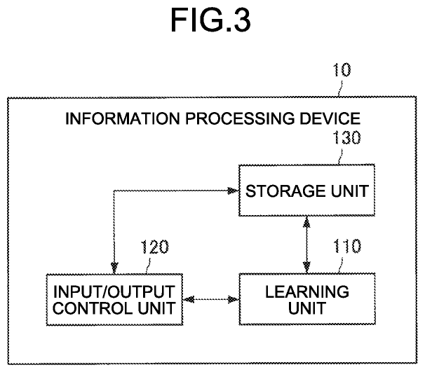

First, the functional configuration example of the information processing device 10 according to an embodiment of the present disclosure will be described. FIG. 3 is a block diagram illustrating the functional configuration example of the information processing device 10 according to the present embodiment. Referring to FIG. 1, the information processing device 10 according to the present embodiment includes the learning unit 110, an input/output control unit 120, and a storage unit 130. It is to be noted that the information processing device 10 according to the present embodiment may be connected with an information processing terminal operated by the user via a network.

The network may include a public line network such as the Internet, a telephone line network, and a satellite communication network, a various local area networks (LAN) including Ethernet (registered trademark), and a wide area network (WAN). In addition, a network 30 may also include a dedicated line network such as an Internet protocol-virtual private network (IP-VPN). In addition, the network 30 may also include a wireless communication network such as Wi-Fi (registered trademark) and Bluetooth (registered trademark).

(Learning Unit 110)

The learning unit 110 according to the present embodiment has a function of performing various types of learning using the neural network. In addition, the learning unit 110 according to the present embodiment performs quantization of weights and biases at the time of learning using a quantization function.

At this time, one of the characteristics of the learning unit 110 according to the present embodiment is to optimize parameters that determine the dynamic range by the error back propagation and the stochastic gradient descent in a quantization function of a neural network in which the parameters that determine the dynamic range are arguments. The function of the learning unit 110 according to the present embodiment will be described in detail separately.

(Input/Output Control Unit 120)

The input/output control unit 120 according to the present embodiment controls the API for the user to perform settings related to learning and quantization by the learning unit 110. The input/output control unit 120 according to the present embodiment acquires various values having been input by the user via the API and delivers them to the learning unit 110. In addition, the input/output control unit 120 according to the present embodiment can present parameters optimized on the basis of the various values to the user via the API. The function of the input/output control unit according to the present embodiment will be separately described in detail later.

(Storage Unit 130)

The storage unit 130 according to the present embodiment has a function of storing programs and data used in each configuration included in the information processing device 10. The storage unit 130 according to the present embodiment stores various parameters used for learning and quantization by the learning unit 110, for example.

A functional configuration example of the information processing device 10 according to the present embodiment has been described above. It is to be noted that the configuration described above with reference to FIG. 2 is merely an example, and the functional configuration of the information processing device 10 according to the present embodiment is not limited to the example. The functional configuration of the information processing device 10 according to the present embodiment can be flexibly modified according to the specifications and operations.

### 1.3. Details of Optimization

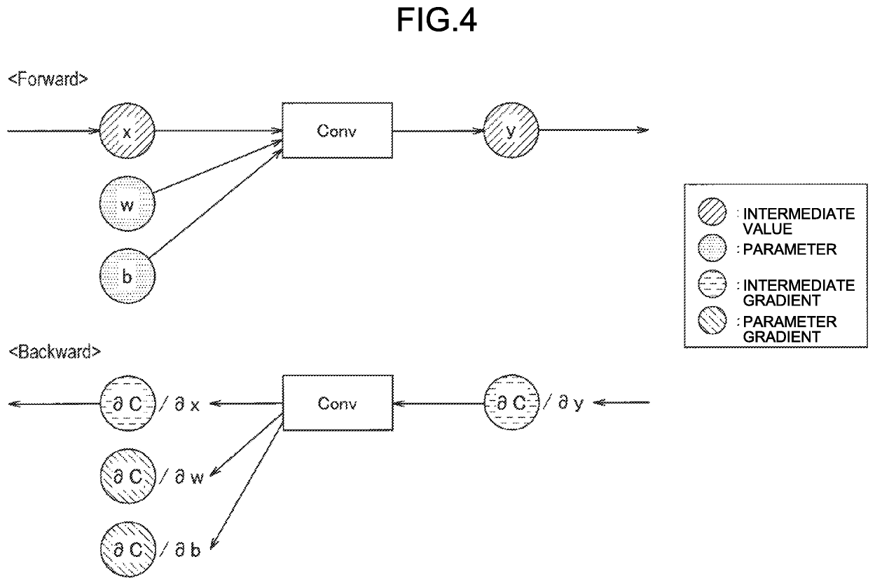

Next, optimization of the parameter by the learning unit 110 according to the present embodiment will be described in detail. First, an object to be quantized by the learning unit 110 according to the present embodiment will be described. FIG. 4 is a diagram for explaining a learning sequence by the learning unit 110 according to the present embodiment.

As illustrated in FIG. 4, the learning unit 110 according to the present embodiment performs various types of learning by the error back propagation. The learning unit 110 performs an inner product operation or the like on the basis of the intermediate value having been output from the upstream layer and learning parameters such as a weight w and a bias b in a forward direction as illustrated in the upper part of FIG. 4, and outputs the operation result to the downstream layer, thereby performing forward propagation.

In addition, the learning unit 110 according to the present embodiment performs backward propagation by calculating a partial differential of the learning parameters such as the weight and the bias on the basis of a parameter gradient output from a downstream layer in a backward direction as illustrated in the lower part of FIG. 4.

In addition, the learning unit 110 according to the present embodiment updates learning parameters such as the weight and the bias so as to minimize the error by the stochastic gradient descent. At this time, the learning unit 110 according to the present embodiment can update the learning parameter using the following Expression (3), for example. Although Expression (3) indicates an expression for updating the weight w, other parameters can be updated by the similar calculation. In Expression (3), C represents cost and t represents iteration.

wₜ←wₜ₋₁−η∂C/∂w (3)

Thus, the learning unit 110 according to the present embodiment advances learning by performing forward propagation, backward propagation, and update of learning parameters. At this time, the learning unit 110 according to the present embodiment quantizes the learning parameters such as the weight w and the bias described above using the quantization function, thereby allowing the operation load to be reduced.

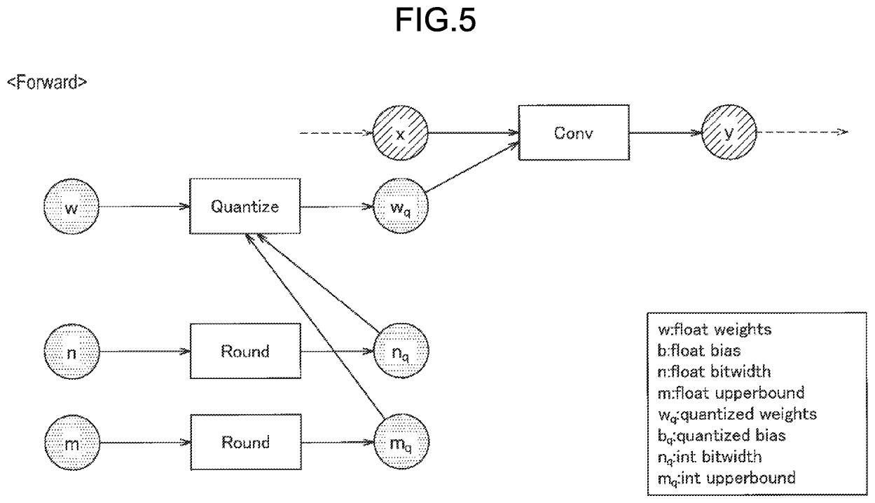

FIG. 5 is a calculation graph for explaining quantization of the learning parameter using the quantization function according to the present embodiment. As illustrated in FIG. 5, the learning unit 110 according to the present embodiment quantizes the weight w held in a float type into a weight wq of an int type by the quantization function.

At this time, the learning unit 110 according to the present embodiment can similarly quantize the weight w of the float type into the weight wq of the int type on the basis of a bit length nq and an upper limit value mq that have been quantized from the float type to the int type.

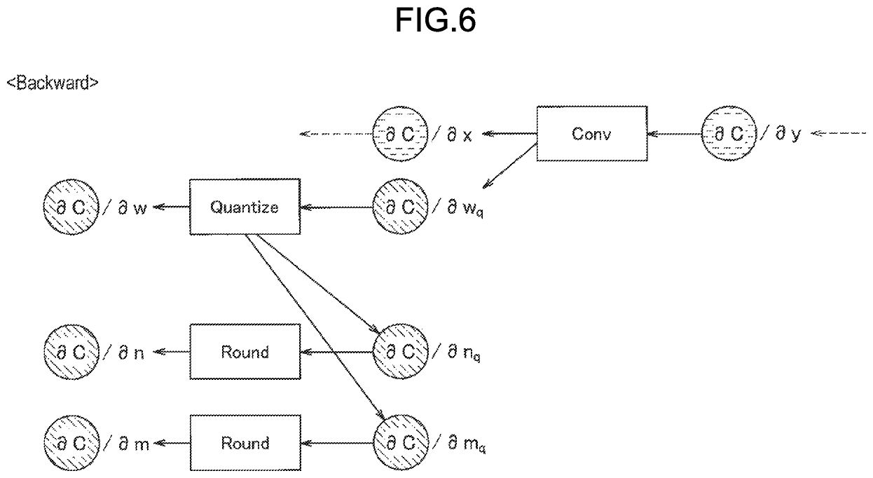

In addition, FIG. 6 is a diagram for explaining backward propagation related to the quantization function according to the present embodiment. In many cases, the quantization functions such as “Quantize” and “Round” illustrated in FIGS. 5 and 6 cannot be analytically differentiated. Therefore, in the backward propagation related to the quantization functions as described above, the learning unit 110 according to the present embodiment may perform replacement to a differential result of an approximate function by a straight through estimator (STE). In the simplest case, the learning unit 110 may replace the differential result of the quantization function with the differential result of the linear function.

The learning and quantization by the learning unit 110 according to the present embodiment have been outlined. Subsequently, the optimization of the parameters that determine the dynamic range by the learning unit 110 according to the present embodiment * will be described in detail.

It is to be noted that in the following, an example of calculation in the case where the learning unit 110 according to the present embodiment performs optimization of parameters that determine the dynamic range in linear quantization and power-of-two quantization will be described.

In addition, in the following, the value quantized in the linear quantization is expressed by the following Expression (4). At this time, the learning unit 110 according to the present embodiment optimizes the bit length n and the step size δ as parameters that determine the dynamic range.

k·δ with k∈[0,2ⁿ−1](‘sign=False’)

or ±k·δ with k∈[0,2ⁿ⁻¹−1](‘sign=True’) (4)

In addition, in the following, the value to be quantized in the power-of-two quantization is expressed by the following Expression (5). At this time, the learning unit 110 according to the present embodiment optimizes the bit length n and the upper (lower) limit value as parameters that determine the dynamic range.

[Expression 5]

2^{k} with k∈[m−2ⁿ+1,m](‘with_zero=False’,sign=‘False’)

±2^{k} with k∈[m−2ⁿ⁻¹+1,m](‘with_zero=False’,sign=‘True’)

{0,2^{k}} with k∈[m−2ⁿ⁻¹+1,m](‘with_zero=True’,sign=‘False’)

{0,±2^{k}} with k∈[m−2ⁿ⁻²+1,m](‘with_zero=True’,sign=‘True’) (5)

In addition, the quantization and the optimization of the parameters that determine dynamic range are performed in the affine layer or the convolution layer.

In addition, the gradient given is related to the input/output of a scalar value, and λ∈{n, m, δ} related to a cost function C is given by the chain rule.

Here, an output y∈R to an input x∈R of the scalar value is also a scalar value, and the gradient of the cost function C related to the parameter is expressed by the following Expression (6).

$$\frac{\partial C}{\partial λ} = \frac{\partial y}{\partial λ} \frac{\partial C}{\partial y} \qquad ( 6 )$$

In addition, an output y∈R^{I} of the vector value to an input x∈R^{I} is also a vector value, and the gradient of the cost function C related to the parameter is expressed by the following Expression (7) as all the outputs yᵢ based on λ.

$$\frac{\partial C}{\partial λ} = {\sum }_{i = 1}^{I} \frac{\partial {y}_{i}}{\partial λ} \frac{\partial C}{\partial {y}_{i}} \qquad ( 7 )$$

The premise related to the optimization of the parameters that determine the dynamic range according to the present embodiment has been described above. Subsequently, the optimization of the parameters in each quantization technique will be described in detail.

First, the optimization of the parameters related to linear quantization where negative values are not permitted by the learning unit 110 according to the present embodiment will be described. Here, let the bit length n and the step size δ in the forward propagation be [minₙ, maxₙ] and [min_{δ}, max_{δ}], respectively, and let the bit length n quantized to the int type by a round function be n_{q}. At this time, the quantization of the input value is expressed by the following Expression (8).

$$y = δ \cdot \{ \begin{matrix}0 & x < 0 \\ ⌊ \frac{x}{δ} + 0.5 ⌋ & 0 \leq x \leq ( {2}^{{n}_{q}} - 1 ) δ \\ {2}^{{n}_{q}} - 1 & ( {2}^{{n}_{q}} - 1 ) δ < x\end{matrix} \qquad ( 8 )$$

In addition, the gradient of the bit length n and the gradient of the step size δ are expressed in the backward propagation by the following Expressions (9) and (10), respectively.

$$\begin{matrix}\frac{\partial y}{\partial n} = δ \cdot \{ \begin{matrix}0 & x < 0 \\ 0 & 0 \leq x \leq ( {2}^{{n}_{q}} - 1 ) δ \\ {2}^{{n}_{q}} ln 2 & ( {2}^{{n}_{q}} - 1 ) δ < x\end{matrix} & ( 9 ) \\ \frac{\partial y}{\partial δ} = \{ \begin{matrix}0 & x < 0 \\ ⌊ \frac{x}{δ} + 0.5 ⌋ & 0 \leq x \leq ( {2}^{{n}_{q}} - 1 ) δ \\ {2}^{{n}_{q}} - 1 & ( {2}^{{n}_{q}} - 1 ) δ < x\end{matrix} & ( 10 )\end{matrix}$$

Next, the optimization of the parameters related to linear quantization where negative values are permitted by the learning unit 110 according to the present embodiment will be described. Here, let the bit length n and the step size δ in the forward propagation be [minₙ, maxₙ] and [min_{δ}, max_{δ}], respectively, and let the bit length n quantized to the int type by a round function be n_{q}. At this time, the quantization of the input value is expressed by the following Expression (11).

$$y = δ \cdot sign ( x ) \cdot \{ \begin{matrix}{2}^{{n}_{q} - 1} - 1 & \vert x \vert > - ( {2}^{{n}_{q} - 1} - 1 ) δ \\ ⌊ \frac{x}{δ} + 0.5 ⌋ & \vert x \vert \leq ( {2}^{{n}_{q} - 1} - 1 ) δ\end{matrix} \qquad ( 11 )$$

In addition, the gradient of the bit length n and the gradient of the step size δ are expressed in the backward propagation by the following Expressions (12) and (13), respectively.

$$\begin{matrix}\frac{\partial y}{\partial n} = δ \cdot sign ( x ) \cdot \{ \begin{matrix}{2}^{{n}_{q} - 1} ln 2 & \vert x \vert > - ( {2}^{{n}_{q} - 1} - 1 ) δ \\ 0 & \vert x \vert \leq ( {2}^{{n}_{q} - 1} - 1 ) δ\end{matrix} & ( 12 ) \\ \frac{\partial y}{\partial δ} = sign ( x ) \cdot \{ \begin{matrix}{2}^{{n}_{q} - 1} - 1 & \vert x \vert > ( {2}^{{n}_{q} - 1} - 1 ) δ \\ ⌊ \frac{\vert x \vert}{δ} + 0.5 ⌋ & \vert x \vert \leq ( {2}^{{n}_{q} - 1} - 1 ) δ\end{matrix} & ( 13 )\end{matrix}$$

Next, the optimization of the parameters related to power-of-two quantization where negative values and 0 are not permitted by the learning unit 110 according to the present embodiment will be described. Here, let the bit length n and the upper (lower) limit value m in the forward propagation be [minₙ, maxₙ] and [minₘ, maxₘ], respectively, and let the bit length n and the upper (lower) limit value m that are quantized to the int type by the round function be n_{q} and m_{q}, respectively. At this time, the quantization of the input value is expressed by the following Expression (14).

$$y = \{ \begin{matrix}{2}^{( {m}_{q} - {2}^{n} q + 1 )} & x < {2}^{( {m}_{q} - {2}^{n} q + 1 )} \\ {2}^{⌊ 0.5 + {log}_{2} x ⌋} & {2}^{( {m}_{q} - {2}^{n} q + 1 )} \leq x \leq {2}^{{m}_{q}} \\ {2}^{{m}_{q}} & {2}^{{m}_{q}} < x\end{matrix} \qquad ( 14 )$$

It is to be noted that the value of 0.5 in Expression (14) described above and the expressions thereafter related to power-of-two quantization is a value used for differentiation from the lower limit value, and it may not be limited to 0.5 and may be log₂ 1.5, for example.

In addition, in the backward propagation, the gradient of the bit length n is all 0 except the condition presented by the following Expression (15), and the gradient of the upper (lower) limit value m is expressed by the following Expression (16).

$$\begin{matrix}\frac{\partial y}{\partial n} = - {2}^{( {m}_{q} - {2}^{n} q + 1 )} {2}^{{n}_{q}} {( ln 2 )}^{2} for x < {2}^{( {m}_{q} - {2}^{n} q + 1 )} & ( 15 ) \\ \frac{\partial y}{\partial m} = \{ \begin{matrix}{2}^{( {m}_{q} - {2}^{n} q + 1 )} ln 2 & x < {2}^{( {m}_{q} - {2}^{n} q + 1 )} \\ 0 & {2}^{( {m}_{q} - {2}^{n} q + 1 )} \leq x \leq {2}^{{m}_{q}} \\ {2}^{{m}_{q}} ln 2 & {2}^{{m}_{q}} < x\end{matrix} & ( 16 )\end{matrix}$$

Next, the optimization of the parameters related to power-of-two quantization where negative values are permitted and 0 is not permitted by the learning unit 110 according to the present embodiment will be described. Here, let the bit length n and the upper (lower) limit value m in the forward propagation be [minₙ, maxₙ] and [minₘ, maxₘ], respectively, and let the bit length n and the upper (lower) limit value m that are quantized to the int type by the round function be n_{q} and m_{q}, respectively. At this time, the quantization of the input value is expressed by the following Expression (17).

$$y = sign ( x ) \{ \begin{matrix}{2}^{( {m}_{q} - {2}^{( n} {q}^{- 1 )} + 1 )} & \vert x \vert < {2}^{( {m}_{q} - {2}^{( n} {q}^{- 1 )} + 1 )} \\ {2}^{⌊ 0.5 + {log}_{2} x ⌋} & {2}^{( {m}_{q} - {2}^{( n} {q}^{- 1 )} + 1 )} \leq \vert x \vert \leq {2}^{{m}_{q}} \\ {2}^{{m}_{q}} & {2}^{{m}_{q}} < \vert x \vert\end{matrix} \qquad ( 17 )$$

In addition, in the backward propagation, the gradient of the bit length n is all 0 except the condition indicated by the following Expression (18), and the gradient of the upper (lower) limit value m is expressed by the following Expression (19).

$$\begin{matrix}\frac{\partial y}{\partial n} = - sign ( x ) {2}^{( {m}_{q} - {2}^{( n} {q}^{- 1 )} + 1 )} {2}^{( {n}_{q} - 1 )} {( ln 2 )}^{2} for \vert x \vert < {2}^{( {m}_{q} - {2}^{( n} {q}^{- 1 )} + 1 )} & ( 18 ) \\ \frac{\partial y}{\partial m} = sign ( x ) \{ \begin{matrix}{2}^{( {m}_{q} - {2}^{( n} {q}^{- 1 )} + 1 )} ln 2 & \vert x \vert < {2}^{( {m}_{q} - {2}^{( n} {q}^{- 1 )} + 1 )} \\ 0 & {2}^{( {m}_{q} - {2}^{( n} {q}^{- 1 )} + 1 )} \leq \vert x \vert \leq {2}^{{m}_{q}} \\ {2}^{{m}_{q}} ln 2 & {2}^{{m}_{q}} < \vert x \vert\end{matrix} & ( 19 )\end{matrix}$$

Next, the optimization of the parameters related to power-of-two quantization where negative values are not permitted and 0 is permitted by the learning unit 110 according to the present embodiment will be described. Here, let the bit length n and the upper (lower) limit value m in the forward propagation be [minₙ, maxₙ] and [minₘ, maxₘ], respectively, and let the bit length n and the upper (lower) limit value m that are quantized to the int type by the round function be n_{q} and m_{q}, respectively. At this time, the quantization of the input value is expressed by the following Expression (20).

$$y = \{ \begin{matrix}0 & x < {2}^{( {m}_{q} - {2}^{( n} {q}^{- 1 )} + 0.5 )} \\ {2}^{( {m}_{q} - {2}^{( n} {q}^{- 1 )} + 1 )} & {2}^{( {m}_{q} - {2}^{( n} {q}^{- 1 )} + 0.5 )} \leq x < {2}^{( {m}_{q} - {2}^{( n} {q}^{- 1 )} + 1 )} \\ {2}^{⌊ {log}_{2} x + 0.5 ⌋} & {2}^{( {m}_{q} - {2}^{( n} {q}^{- 1 )} + 1 )} \leq x \leq {2}^{{m}_{q}} \\ {2}^{{m}_{q}} & {2}^{{m}_{q}} < x\end{matrix} \qquad ( 20 )$$

In addition, in the backward propagation, the gradient of the bit length n is all 0 except the condition indicated by the following Expression (21), and the gradient of the upper (lower) limit value m is expressed by the following Expression (22).

$$\begin{matrix}\frac{\partial y}{\partial n} = - {2}^{( {m}_{q} - {2}^{( n} {q}^{- 1 )} + 1 )} {2}^{( {n}_{q} - 1 )} {( ln 2 )}^{2} for {2}^{( {m}_{q} - {2}^{( n} {q}^{- 1 )} + 0.5 )} \leq x < {2}^{( {m}_{q} - {2}^{( n} {q}^{- 1 )} + 1 )} & ( 21 ) \\ \frac{\partial y}{\partial m} = \{ \begin{matrix}0 & x < {2}^{( {m}_{q} - {2}^{( n} {q}^{- 1 )} + 0.5 )} \\ {2}^{( {m}_{q} - {2}^{( n} {q}^{- 1 )} + 1 )} ln 2 & {2}^{( {m}_{q} - {2}^{( n} {q}^{- 1 )} + 0.5 )} \leq x < {2}^{( {m}_{q} - {2}^{( n} {q}^{- 1 )} + 1 )} \\ 0 & {2}^{( {m}_{q} - {2}^{( n} {q}^{- 1 )} + 1 )} \leq x \leq {2}^{{m}_{q}} \\ {2}^{{m}_{q}} ln 2 & {2}^{{m}_{q}} < x\end{matrix} & ( 22 )\end{matrix}$$

Next, the optimization of the parameters related to power-of-two quantization where both negative values and 0 are permitted by the learning unit 110 according to the present embodiment will be described. Here, let the bit length n and the upper (lower) limit value m in the forward propagation be [minₙ, maxₙ] and [minₘ, maxₘ], respectively, and let the bit length n and the upper (lower) limit value m that are quantized to the int type by the round function be n_{q} and m_{q}, respectively. At this time, the quantization of the input value is expressed by the following Expression (23).

$$y = sign ( x ) \{ \begin{matrix}0 & \vert x \vert < {2}^{( {m}_{q} - {2}^{( n} {q}^{- 2 )} + 0.5 )} \\ {2}^{( {m}_{q} - {2}^{( n} {q}^{- 2 )} + 1 )} & {2}^{( {m}_{q} - {2}^{( n} {q}^{- 2 )} + 0.5 )} \leq \vert x \vert < {2}^{( {m}_{q} - {2}^{( n} {q}^{- 2 )} + 1 )} \\ {2}^{⌊ {log}_{2} \vert x \vert + 0.5 ⌋} & {2}^{( {m}_{q} - {2}^{( n} {q}^{- 2 )} + 1 )} \leq \vert x \vert \leq {2}^{{m}_{q}} \\ {2}^{{m}_{q}} & {2}^{{m}_{q}} < \vert x \vert\end{matrix} \qquad ( 23 )$$

In addition, in the backward propagation, the gradient of the bit length n is all 0 except the condition presented by the following Expression (24), and the gradient of the upper (lower) limit value m is expressed by the following Expression (25).

$$\begin{matrix}\frac{\partial y}{\partial n} = - sign ( x ) {2}^{( {m}_{q} - {2}^{( n} {q}^{- 2 )} + 1 )} {2}^{( {n}_{q} - 2 )} {( ln 2 )}^{2} for {2}^{( {m}_{q} - {2}^{( n} {q}^{- 2 )} + 0.5 )} \leq x < {2}^{( {m}_{q} - {2}^{( n} {q}^{- 2 )} + 1 )} & ( 24 ) \\ \frac{\partial y}{\partial m} = sign ( x ) \{ \begin{matrix}0 & \vert x \vert < {2}^{( {m}_{q} - {2}^{( n} {q}^{- 2 )} + 0.5 )} \\ {2}^{( {m}_{q} - {2}^{( n} {q}^{- 2 )} + 1 )} ln 2 & {2}^{( {m}_{q} - {2}^{( n} {q}^{- 2 )} + 0.5 )} \leq \vert x \vert < {2}^{( {m}_{q} - {2}^{( n} {q}^{- 2 )} + 1 )} \\ {2}^{⌊ {log}_{2} \vert x \vert + 0.5 ⌋} & {2}^{( {m}_{q} - {2}^{( n} {q}^{- 2 )} + 1 )} \leq \vert x \vert \leq {2}^{{m}_{q}} \\ {2}^{{m}_{q}} ln 2 & {2}^{{m}_{q}} < \vert x \vert\end{matrix} & ( 25 )\end{matrix}$$

### 1.4. Effects

Next, effects of optimization of parameters that determine the dynamic range according to the present embodiment will be described. First, results of classification using CIFAR-10 will be described. It is to be noted that ResNet-20 was adopted as the neural network.

In addition, here, as the initial value of the bit length n in all layers, 4 bits or 8 bits was set, and three experiments were conducted in which the weight w was quantized by linear quantization, power-of-two quantization where 0 is not permitted, and power-of-two quantization where 0 is permitted.

In addition, as the initial value of the upper limit value m of the power-of-two quantization, the value calculated by the following Expression (26) was used for all layers.

$${m}_{init} ⌈ {log}_{2} {max}_{ij} \vert {w}_{ij} \vert ⌉ \qquad ( 26 )$$

In addition, as the initial value of the step size δ of the linear quantization, the value of the power of 2 calculated by the following Expression (27) was used for all layers.

$${δ}_{init} {2}^{⌈ {log}_{2} \frac{{max}_{ij} \vert {w}_{ij} \vert}{{2}^{( {n}_{init} - 1 )} - 1} ⌉} \qquad ( 27 )$$

In addition, as the permissible range of each parameter, n∈[2, 8], m∈[−16, 16], and δ∈[2⁻¹², 2⁻²] were set.

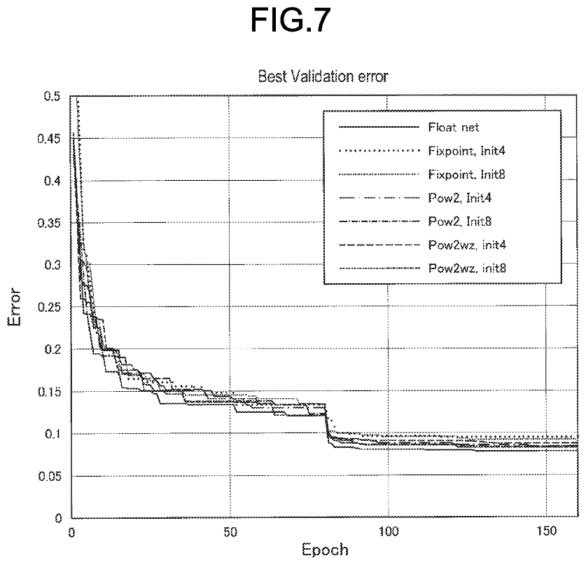

First, the result of the best validation error in each condition is illustrated in FIG. 7. Referring to FIG. 7, it is understood that there is no significant difference between the error when quantization was performed under each condition and the error of Float Net where quantization was not performed. This indicates that the optimization technique of parameters that determine the dynamic range according to the present embodiment is capable of realizing quantization without substantially reducing the learning accuracy.

It is to be noted that the detailed value of the error in each condition is as follows. In FIG. 7 and the following description, the power-of-two quantization is indicated as “Pow2” and the setting not permitting 0 is indicated as “wz”.

Float Net 7.84%

FixPoint, Init4: 9.49%

FixPoint, Init8: 9.23%

Pow2, Init4: 8.42%

Pow2, Init8: 8.40%

Pow2wz, Init4: 8.74%

Pow2wz, Init8: 8.28%

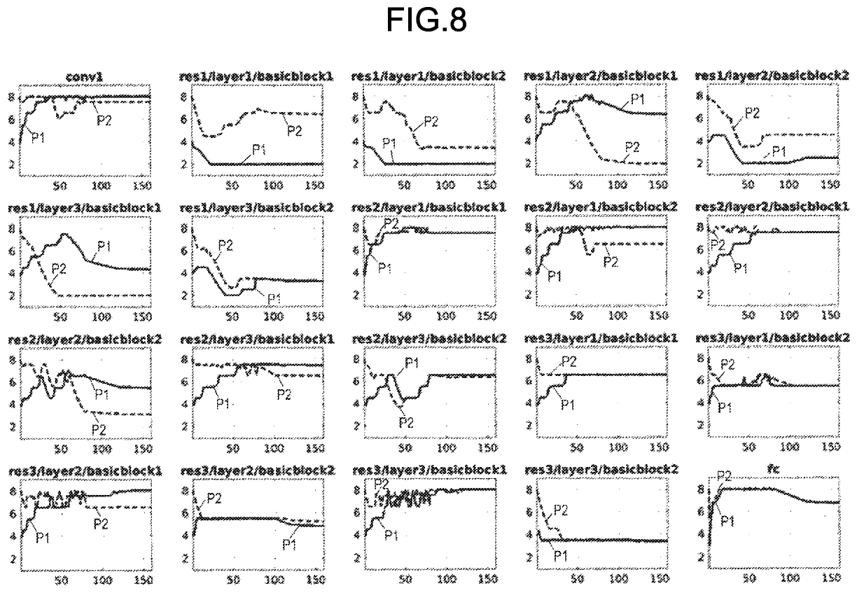

Next, the optimization result of the parameters in each layer will be presented. FIG. 8 are graphs obtained by observing changes in the bit length n when linear quantization was performed. It is to be noted that in FIG. 8, the transition of the bit length n when 4 bits were given as the initial value is indicated by P1, and the transition of the bit length n when 8 bits were given as the initial value is indicated by P2.

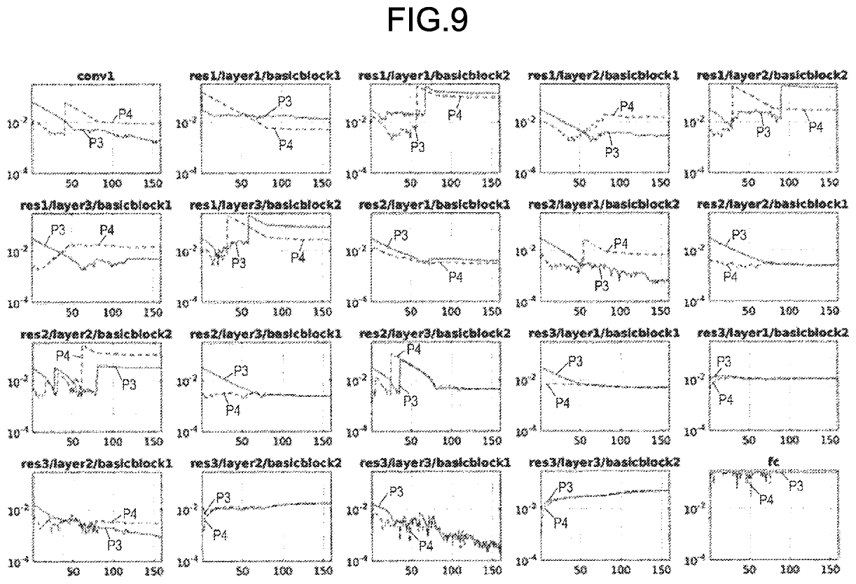

In addition, FIG. 9 are graphs obtained by observing changes in the step size δ when linear quantization was performed. In FIG. 9, the transition of the step size δ when 4 bits were given as the initial value is indicated by P3, and the transition of the step size δ when 8 bits were given as the initial value is indicated by P4.

Referring to FIGS. 8 and 9, it is understood that the bit length n and the step size δ converge to a certain value over time in almost all layers.

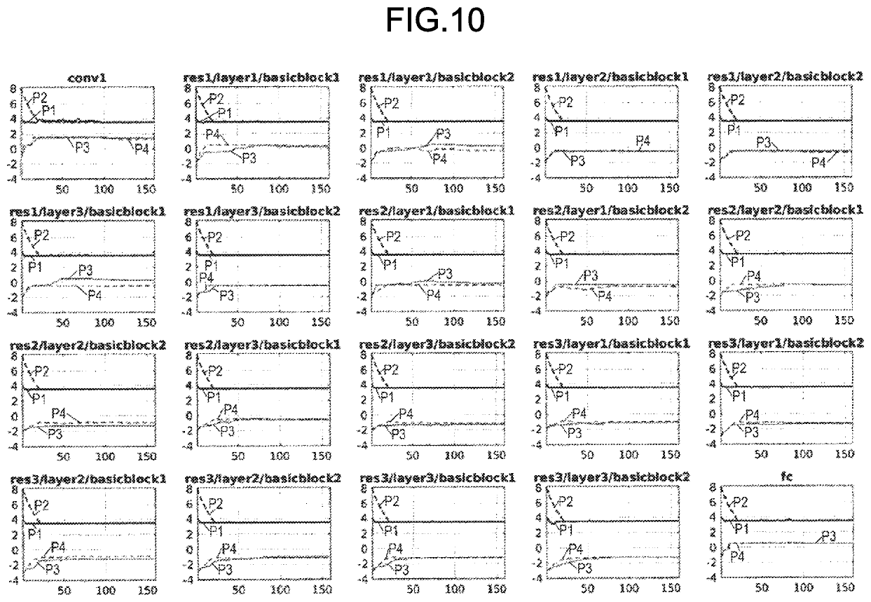

In addition, FIG. 10 are graphs obtained by observing changes in the bit length n and the upper limit value m when power-of-two quantization where 0 is not permitted was performed. In FIG. 10, the transition of the bit length n when 4 bits were given as the initial value is indicated by P1, and the transition of the bit length n when 8 bits were given as the initial value is indicated by P1. In addition, in FIG. 10, the transition of the upper limit value m when 4 bits were given as the initial value is indicated by P3, and the transition of the upper limit value m when 8 bits were given as the initial value is indicated by P4.

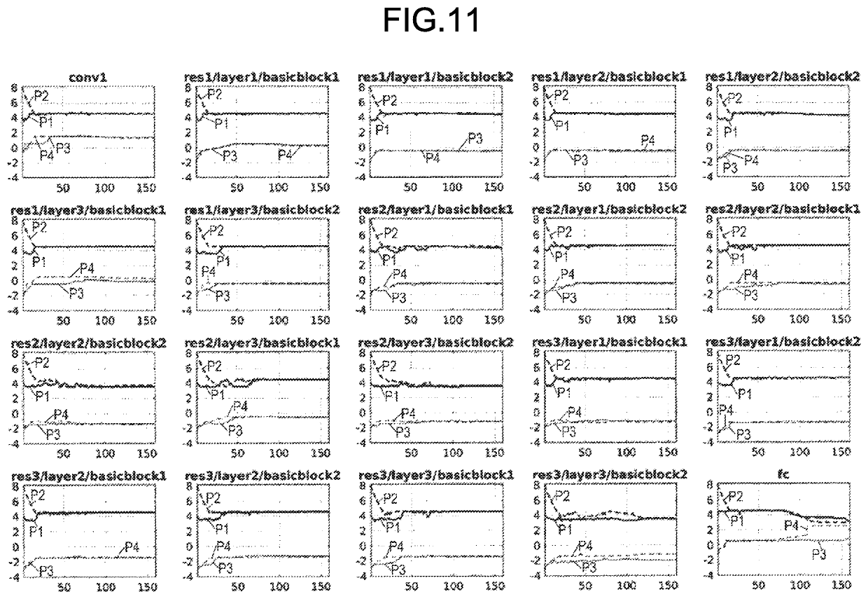

In addition, FIG. 11 are graphs obtained by observing changes in the bit length n and the upper limit value m when power-of-two quantization where 0 is permitted was performed. Also in FIG. 11, the transition of the bit length n when 4 bits were given as the initial value is indicated by P1, and the transition of the bit length n when 8 bits were given as the initial value is indicated by P1. In addition, the transition of the upper limit value m when 4 bits were given as the initial value is indicated by P3, and the transition of the upper limit value m when 8 bits were given as the initial value is indicated by P4.

Referring to FIGS. 8 and 9, it is understood that the bit length n converges to around 4 and the upper limit value m converges to around 0 over time in almost all layers in the power-of-two quantization. This result indicates that the optimization of the parameters that determine the dynamic range according to the present embodiment is performed with very high accuracy.

As described above, according to the optimization of the parameters that determine the dynamic range according to the present embodiment, it is possible to automatically optimize each parameter for each layer regardless of the quantization technique, and it is possible to dramatically reduce the load of manual searching and to greatly reduce the operation load in a huge neural network.

Next, experiment results when quantization of the intermediate value was performed are presented. Here, ReLU was replaced in the power-of-two quantization where 0 is permitted and negative values are not permitted. In addition, as the data set, CIFAR-10 was used similarly to the quantization of the weight.

In addition, as the setting of each parameter, n∈[3, 8] and the initial value of 8 bits, m∈[−16, 16] were set.

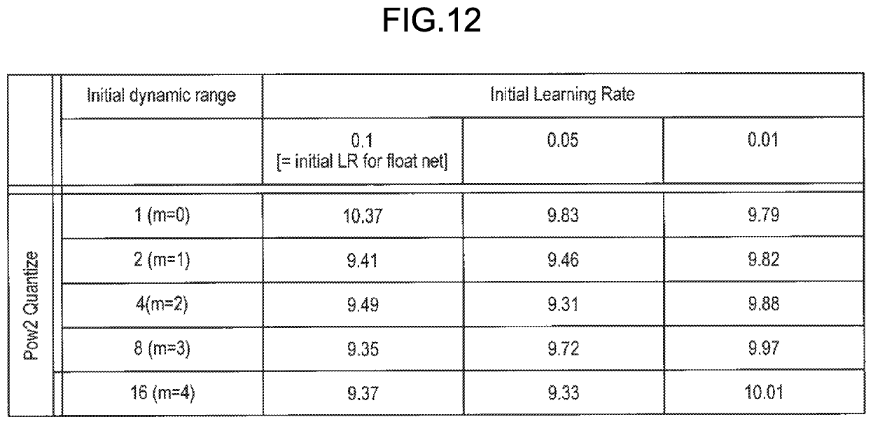

FIG. 12 presents a result of a best validation error in quantization of the intermediate value according to the present embodiment. Referring to FIG. 12, it is understood that according to the optimization of the parameters that determine the dynamic range according to the present embodiment, also in the quantization of the intermediate value, the quantization can be realized without substantially lowering the learning accuracy.

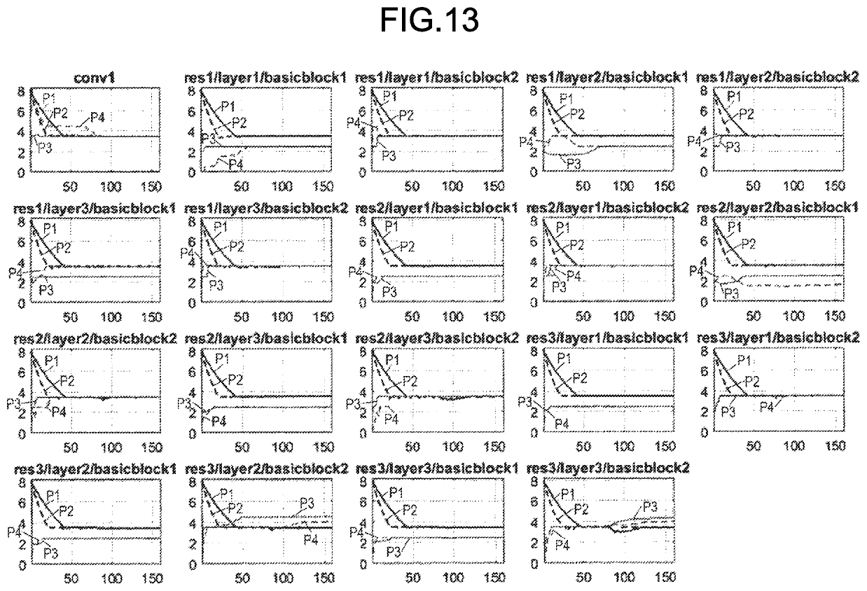

In addition, FIG. 13 is a graph obtained by observing changes in each parameter when quantization of the intermediate value was performed. It is to be noted that in FIG. 13, the transition of the bit length n when a best validation error was obtained is indicated by P1, and the transition of the bit length n when a worst validation error was obtained is indicated by P2. In addition, in FIG. 13, the transition of the upper limit value m when the best validation error was obtained is indicated by P3, and the transition of the upper limit value m when the worst validation error was obtained is indicated by P4.

Referring to FIG. 13, it is understood that the bit length n converges to around 4 over time in almost all layers, also when the quantization of the intermediate value was performed. In addition, it is understood that the upper limit value m converges to around 4 or 2 over time when the quantization of the intermediate value was performed.

Subsequently, experiment results when quantization of the weight w and quantization of the intermediate value were performed simultaneously are presented. Also in this experiment, as the data set, CIFAR-10 was used similarly to the quantization of the weight. In addition, as the setting of each parameter, n∈[2, 8] and the initial value of 2, 4, or 8 bits, m∈[−16, 16] and the initial value m=0 were set.

It is to be noted that the experiments were conducted with initial learning rates of 0.1 and 0.01.

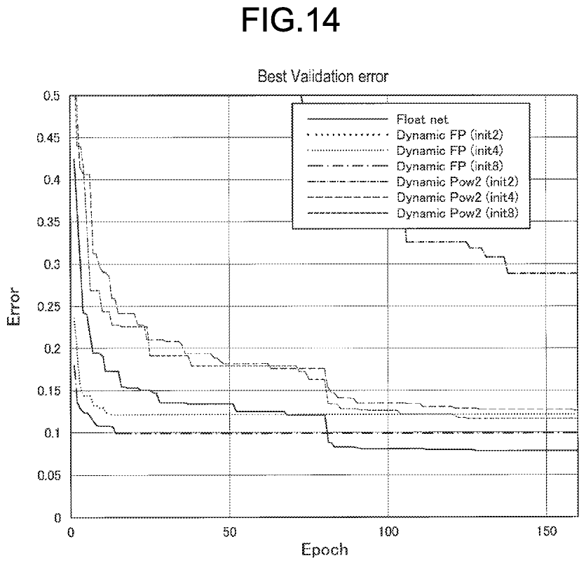

FIG. 14 illustrates a result of a best validation error when quantization of the weight w and quantization of the intermediate value are performed simultaneously according to the present embodiment. Referring to FIG. 14, it is understood that although the accuracy is slightly lower than that in the case where the weight w and the intermediate value are individually quantized, the quantization can be realized without significantly lowering the learning accuracy, except power-of-two quantization with the initial value of 2 bits.

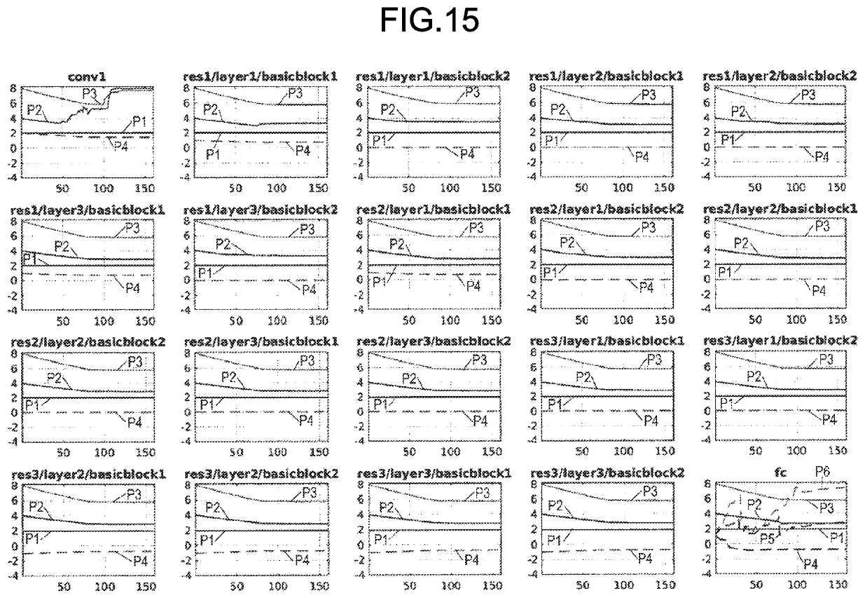

In addition, FIG. 15 are graphs obtained by observing changes in each parameter related to linear quantization of the weight w. It is to be noted that in FIG. 15, transitions of the bit length n when 2, 4, and 8 bits were given as initial values are indicated by P1, P2, and P3, respectively. In addition, in FIG. 15, transitions of the upper limit value m when 2, 4, and 8 bits were given as initial values of the bit length n are indicated by P4, P5, and P6, respectively. As described above, in the linear quantization according to the present embodiment, the upper limit value m may be optimized instead of the step size δ. In this case, it is possible to further simplify learning. It is to be noted that at this time, the optimized step size δ can be calculated backward from the optimized upper limit value m. In addition, for the layer where P4 to P6 overlap in the figure, only P4 is given a reference sign.

Referring to FIG. 15, it is understood that when linear quantization of the weight w and linear quantization of the intermediate value were performed simultaneously, the bit length n related to the weight w converges to a different value depending on the initial value. On the other hand, the upper limit value m converges to around 0 in many layers.

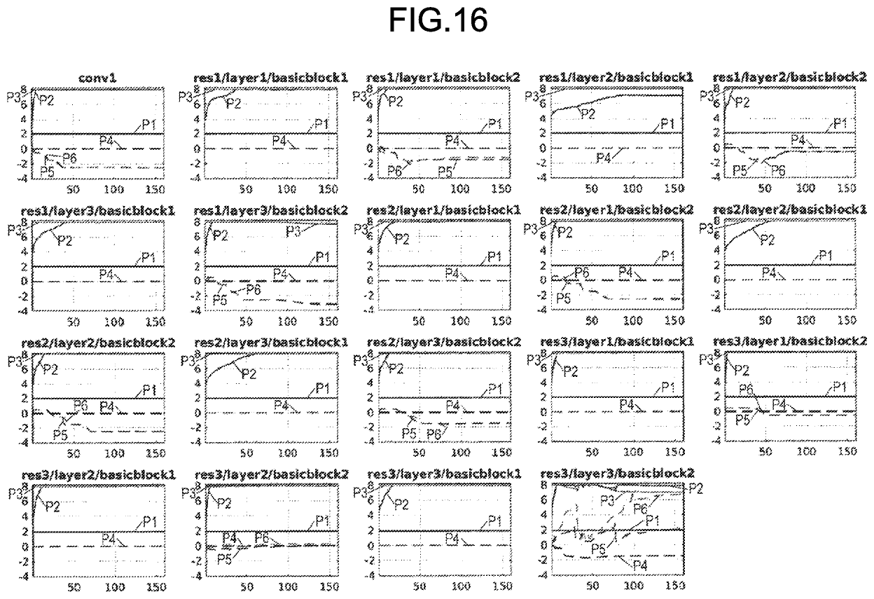

In addition, FIG. 16 are graphs obtained by observing changes in each parameter related to linear quantization of the intermediate value. It is to be noted that also in FIG. 16, transitions of the bit length n when 2, 4, and 8 bits were given as initial values are indicated by P1, P2, and P3, respectively. In addition, transitions of the upper limit value m when 2, 4, and 8 bits were given as initial values of the bit length n are indicated by P4, P5, and P6, respectively. In addition, for the layer where P4 to P6 overlap in the figure, only P4 is given a reference sign.

Referring to FIG. 16, it is understood that when linear quantization of the weight w and linear quantization of the intermediate value were performed simultaneously, the bit length n related to the intermediate value converges to around 2 when the initial value is 2 bits, and converges to around 8 when the initial value is 4 or 8 bits. On the other hand, the upper limit value m converges to around 0 in many layers, as in the case of the weight w.

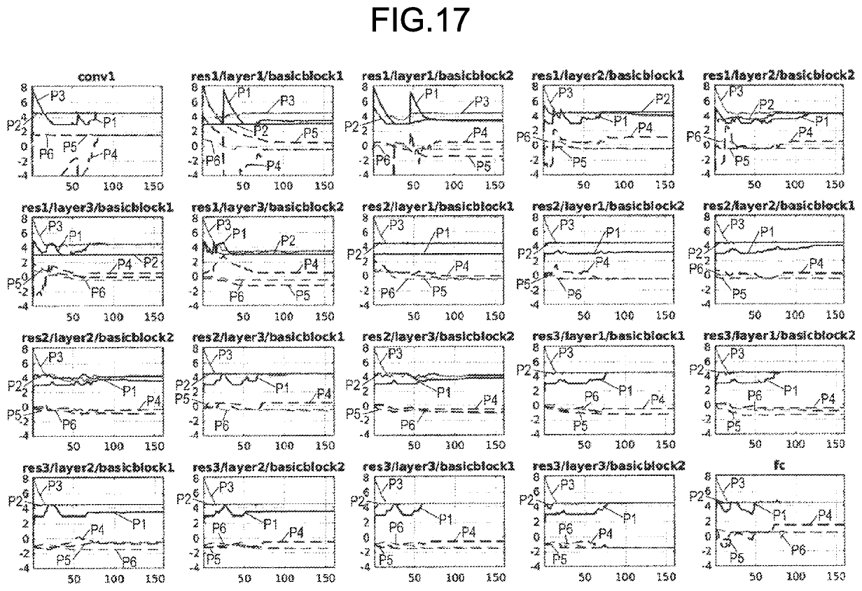

In addition, FIG. 17 are graphs obtained by observing changes in each parameter related to power-of-two quantization of the weight w. It is to be noted that in FIG. 17, transitions of the bit length n when 2, 4, and 8 bits were given as initial values are indicated by P1, P2, and P3, respectively. In addition, in FIG. 17, transitions of the upper limit value m when 2, 4, and 8 bits were given as initial values of the bit length n are indicated by P4, P5, and P6, respectively.

Referring to FIG. 17, it is understood that when power-of-two quantization of the weight w and power-of-two quantization of the intermediate value are performed simultaneously, the bit length n related to the weight w finally converges to around 4 regardless of the initial value. In addition, the upper limit value m converges to around 0 in many layers.

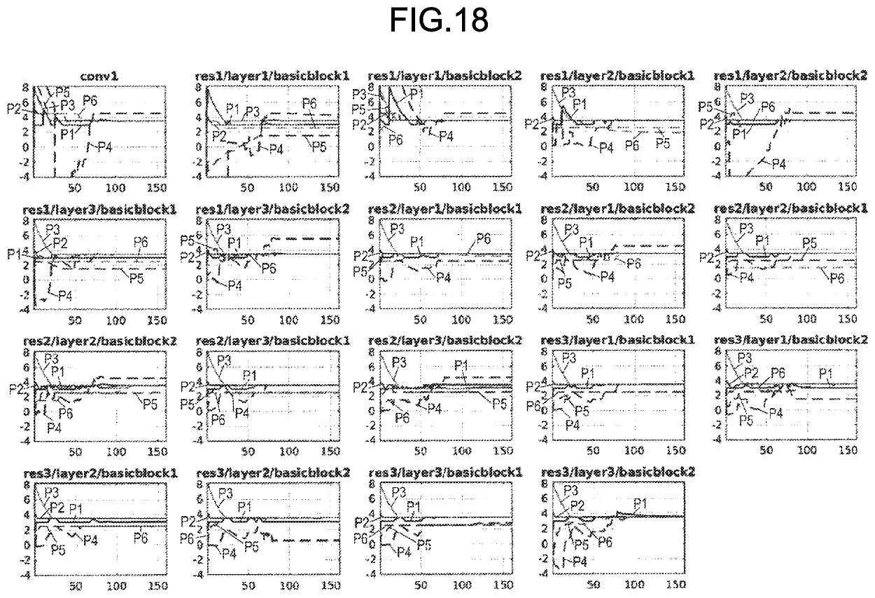

In addition, FIG. 18 are graphs obtained by observing changes in each parameter related to power-of-two quantization of the intermediate value. It is to be noted that also in FIG. 18, transitions of the bit length n when 2, 4, and 8 bits were given as initial values are indicated by P1, P2, and P3, respectively. In addition, transitions of the upper limit value m to which 2, 4, and 8 bits were given as initial values of the bit length n are indicated by P4, P5, and P6, respectively.

Referring to FIG. 18, it is understood that when power-of-two quantization of the weight w and power-of-two quantization of the intermediate value are performed simultaneously, the bit length n related to the intermediate value finally converges to around 4 in many layers. In addition, the upper limit value m converges to around 2 in many layers.

The effects of optimization of parameters that determine the dynamic range according to the present embodiment have been described above. According to the optimization of the parameters that determine the dynamic range according to the present embodiment, it is possible to automatically optimize each parameter for each layer regardless of the quantization technique, and it is possible to dramatically reduce the load of manual searching and to greatly reduce the operation load in a huge neural network.

### 1.5. API Details

Next, the API controlled by the input/output control unit 120 according to the present embodiment will be described in detail. As described above, the input/output control unit 120 according to the present embodiment controls the API for the user to perform settings related to learning and quantization by the learning unit 110. The API according to the present embodiment is used, for example, for the user to input, for each layer, initial values of the parameters that determine the dynamic range and various settings related to quantization, for example, setting of whether or not to permit negative values or 0.

At this time, the input/output control unit 120 according to the present embodiment can acquire the set value input by the user via the API, and return, to the user, the parameters that determine the dynamic range optimized by the learning unit 110 on the basis of the set value.

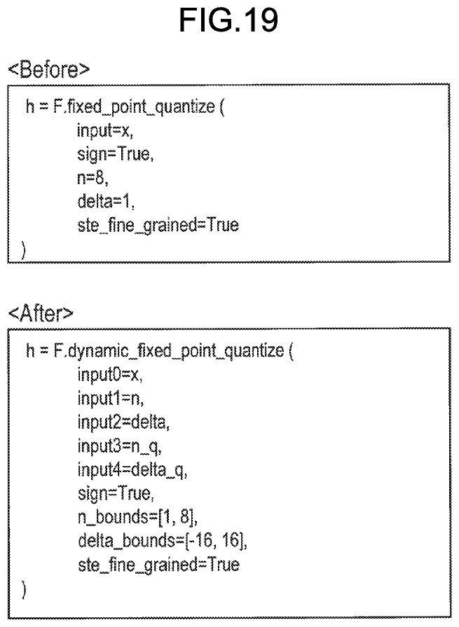

FIG. 19 are figures for explaining the API when performing the linear quantization according to the present embodiment. The upper part of FIG. 19 illustrates the API when not performing optimization of the parameters that determine the dynamic range according to the present embodiment, and the lower part of FIG. 19 illustrates the API when performing optimization of the parameters that determine the dynamic range according to the present embodiment.

Here, focusing on the upper part of FIG. 19, in the API when not performing optimization of the parameters that determine the dynamic range according to the present embodiment, the user can input, for example, a variable for storing the input from the layer of the preceding stage, setting of whether or not to permit negative values, the bit length n, the step size δ, setting of whether to use the STE with high granularity or to use the simple STE, and the like in order from the top, and the user can obtain an output value h of the corresponding layer.

On the other hand, in the API of the linear quantization according to the present embodiment illustrated in the lower part of FIG. 19, the user inputs, in order from the top, for example, a variable for storing an input from the layer of the preceding stage, a variable (float) for storing the optimized bit length n, a variable (float) for storing the optimized step size δ, a variable (int) for storing the optimized bit length n, a variable (int) for storing the optimized step size δ, setting of whether or not to permit negative values, a definition area of the bit length n at the time of quantization, a definition area of the step size δ at the time of quantization, and setting of whether to use the STE with high granularity or to use the simple STE.

At this time, the user can obtain, in addition to the output value h of the corresponding layer, the optimized bit length n and the step size δ that are stored in each variable described above. As described above, according to the API controlled by the input/output control unit 120 according to the present embodiment, the user can input the initial value, setting, and the like of each parameter related to quantization, and can easily acquire the value of the optimized parameter.

It is to be noted that although the API when inputting the step size δ is indicated in the example illustrated in FIG. 19, the API according to the present embodiment may be capable of input/output of the upper limit value m also in linear quantization. As described above, the step size δ can be calculated backward from the upper limit value m. As described above, the parameters that determine the dynamic range according to the present embodiment may be a plurality of any parameters, and not limited to the example presented in the present disclosure.

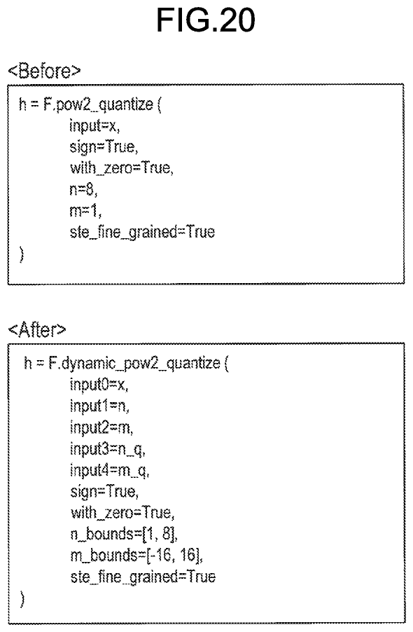

FIG. 20 are figures for explaining the API when performing the power-of-two quantization according to the present embodiment. The upper part of FIG. 20 illustrates the API when not performing optimization of the parameters that determine the dynamic range according to the present embodiment, and the lower part of FIG. 20 illustrates the API when performing optimization of the parameters that determine the dynamic range according to the present embodiment.

Here, focusing on the upper part of FIG. 20, in the API when not performing optimization of the parameters that determine the dynamic range according to the present embodiment, the user can input, for example, a variable for storing the input from the layer of the preceding stage, setting of whether or not to permit negative values, setting of whether or not to permit 0, the bit length n, the upper limit value m, setting of whether to use the STE with high granularity or to use the simple STE, and the like in order from the top, and the user can obtain the output value h of the corresponding layer.

On the other hand, in the API of the power-of-two quantization according to the present embodiment illustrated in the lower part of FIG. 20, the user inputs, in order from the top, for example, a variable for storing an input from the layer of the preceding stage, a variable (float) for storing the optimized bit length n, a variable (float) for storing the optimized upper limit value m, a variable (int) for storing the optimized bit length n, a variable (int) for storing the optimized upper limit value m, setting of whether or not to permit negative values, setting of whether or not to permit 0, a definition area of the bit length n at the time of quantization, a definition area of the upper limit value m at the time of quantization, and setting of whether to use the STE with high granularity or to use the simple STE.

At this time, the user can obtain, in addition to the output value h of the corresponding layer, the optimized bit length n and the upper limit value m that are stored in each variable described above. As described above, the API according to the present embodiment allows the user to perform any setting for each layer and to optimize, for each layer, the parameters that determine the dynamic range.

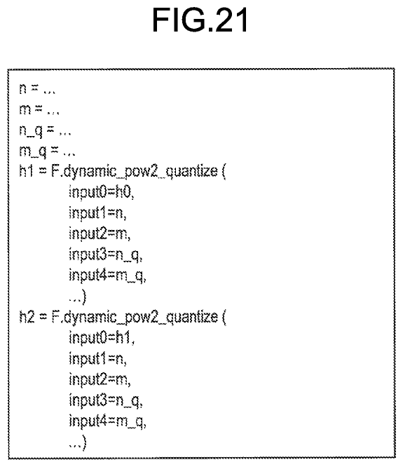

It is to be noted that if it is desired to perform quantization using the identical parameter described above in a plurality of layers, the user may set the identical variable defined upstream in a function corresponding to each layer, as illustrated in FIG. 21, for example. In the case of the example illustrated in FIG. 21, the identical n, m, n_q, and m_q are used in h1 and h2.

As described above, the API according to the present embodiment allows the user to freely set whether to use a different parameter for each layer or to use different parameters common to a plurality of any layers (for example, a block or all target layers). The user can perform setting for using the identical n and n_q in a plurality of layers, and at the same time, using m and m_q different in each layer, for example.

### 2. HARDWARE CONFIGURATION EXAMPLE

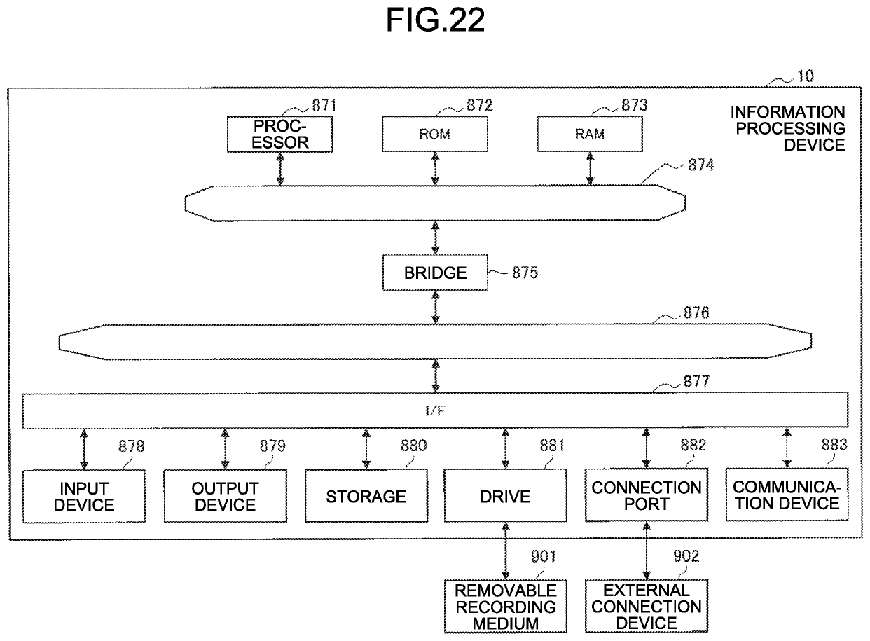

Next, a hardware configuration example of the information processing device 10 according to an embodiment of the present disclosure will be described. FIG. 22 is a block diagram illustrating a hardware configuration example of the information processing device 10 according to an embodiment of the present disclosure. With reference to FIG. 22, the information processing device 10 has, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. It is to be noted that the hardware configuration illustrated here is an example, and some of the components may be omitted. In addition, components other than those illustrated here may be further included.

(Processor 871)

The processor 871 functions as, for example, an arithmetic processing unit or a control unit, and controls the overall operation of each component or a part thereof on the basis of various programs recorded in the ROM 872, the RAM 873, the storage 880, or a removable recording medium 901.

(ROM 872, RAM 873)

The ROM 872 is a means for storing a program to be read into the processor 871, data to be used for operation, and the like. The RAM 873 temporarily or permanently stores, for example, a program to be read into the processor 871 and various parameters which change appropriately when the program is executed.

(Host Bus 874, Bridge 875, External Bus 876, Interface 877)

The processor 871, the ROM 872, and the RAM 873 are interconnected via the host bus 874 capable of high-speed data transmission, for example. On the other hand, the host bus 874 is connected to the external bus 876 having a relatively low data transmission speed via the bridge 875, for example. In addition, the external bus 876 is connected to various components via the interface 877.

(Input Device 878)

As the input device 878, for example, a mouse, a keyboard, a touch screen, a button, a switch, a lever, or the like is used. Furthermore, as the input device 878, a remote controller capable of transmitting a control signal using infrared rays or other radio waves is sometimes used. In addition, the input device 878 includes a voice input device such as a microphone.

(Output Device 879)

The output device 879 is a device capable of visually or aurally notifying the user of acquired information, which is a display device such as a cathode ray tube (CRT), an LCD, or an organic EL, an audio output device such as a speaker or a headphone, a printer, a mobile phone, a facsimile or the like. In addition, the output device 879 according to the present disclosure also includes various vibration devices capable of outputting tactile stimulation.

(Storage 880)

The storage 880 is a device for storing various types of data. As the storage 880, for example, a magnetic storage device such as a hard disk drive (HDD), a semiconductor storage device, an optical storage device, a magneto-optical storage device, or the like is used.

(Drive 881)

The drive 881 is a device that reads information recorded on the removable recording medium 901 such as a magnetic disk, an optical disk, a magneto-optical disk, or a semiconductor memory, or writes information on the removable recording medium 901.

(Removable Recording Medium 901)

The removable recording medium 901 is, for example, a DVD medium, a Blu-ray (registered trademark) medium, an HD DVD medium, various semiconductor storage media, or the like. It is a matter of course that the removable recording medium 901 may be, for example, an IC card equipped with a non-contact IC chip, an electronic device, or the like.

(Connection Port 882)

The connection port 882 is a port for connecting an external connection device 902 such as a universal serial bus (USB) port, an IEEE 1394 port, a small computer system interface (SCSI) port, an RS-232C port, or an optical audio terminal.

(External Connection Device 902)

The external connection device 902 is, for example, a printer, a portable music player, a digital camera, a digital video camera, an IC recorder, or the like.

(Communication Device 883)

The communication device 883 is a communication device for connecting to a network, such as a communication card for a wired or wireless LAN, Bluetooth (registered trademark), or wireless USB (WUSB), a router for optical communication, a router for asymmetric digital subscriber line (ADSL), or a modem for various types of communication.

### 3. SUMMARY

As described above, the information processing device 10 that realizes the information processing method according to an embodiment of the present disclosure includes the learning unit 110 that optimizes parameters that determine the dynamic range by the error back propagation and the stochastic gradient descent in the quantization function of the neural network in which the parameters that determine the dynamic range are arguments. According to such a configuration, it is possible to reduce processing load of operation and to realize learning with higher accuracy.

While the preferred embodiment of the present disclosure has been described above in detail with reference to the accompanying drawings, the technical scope of the present disclosure is not limited to such examples. It is obvious that a person having ordinary knowledge in the technical field of the present disclosure can conceive of various variations or modifications within the scope of the technical idea set forth in the claims, and it is understood that such variations or modifications also fall within the technical scope of the present disclosure.

In addition, the effects described herein are illustrative or exemplary and not restrictive. That is, the technology according to the present disclosure can achieve other effects obvious to those skilled in the art from the description herein in addition to the above effects or in place of the above effects.

In addition, it is also possible to create a program for causing hardware such as a CPU, a ROM, and a RAM that are incorporated in the computer to exert functions equivalent to those of the configuration of the information processing device 10, and it is also possible to provide a computer-readable recording medium in which the program is recorded.

It is to be noted that the following structure also falls within the technical scope of the present disclosure.

(1)

An information processing device, comprising:

a learning unit that optimizes parameters that determine a dynamic range by an error back propagation and a stochastic gradient descent in a quantization function of a neural network in which the parameters that determine the dynamic range are arguments.

(2)

The information processing device according to (1), wherein

the parameters that determine the dynamic range include at least a bit length at a time of quantization.

(3)

The information processing device according to (2), wherein

the parameters that determine the dynamic range include an upper limit value or a lower limit value at a time of power quantization.

(4)

The information processing device according to (2) or (3), wherein

the parameters that determine the dynamic range include a step size at a time of linear quantization.

(5)

The information processing device according to any one of (1) to (4), wherein

the learning unit optimizes, for each layer, the parameters that determine the dynamic range.

(6)

The information processing device according to any one of (1) to (5), wherein

the learning unit optimizes, for a plurality of layers in common, the parameters that determine the dynamic range.

(7)

The information processing device according to any one of (1) to (6), wherein

the learning unit optimizes, for an entire neural network in common, the parameters that determine the dynamic range.

(8)

The information processing device according to any one of (1) to (7), further comprising:

an input/output control unit that controls an interface that outputs the parameters that determine the dynamic range optimized by the learning unit.

(9)

The information processing device according to (8), wherein

the input/output control unit acquires an initial value input by a user via the interface, and outputs the parameters that determine the dynamic range optimized on a basis of the initial value.

(10)

The information processing device according to (9), wherein

the input/output control unit acquires an initial value of a bit length input by the user via the interface, and outputs a bit length at a time of quantization optimized on a basis of the initial value of the bit length.

The information processing device according to any one of (8) to (10), wherein

the input/output control unit acquires setting related to quantization input by a user via the interface, and outputs the parameters that determine the dynamic range optimized on a basis of the setting.

(12)

The information processing device according to (11), wherein

setting related to the quantization includes setting of whether or not to permit a quantized value to be a negative value.

(13)

The information processing device according to (11) or (12), wherein

setting related to the quantization includes setting of whether or not to permit a quantized value to be 0.

(14)

The information processing device according to any one of (1) to (13), wherein

the quantization function is used for quantization of at least any of a weight, a bias or an intermediate value.

(15)

An information processing method, by a processor, comprising:

optimizing parameters that determine a dynamic range by an error back propagation and a stochastic gradient descent in a quantization function of a neural network in which the parameters that determine the dynamic range are arguments.

### REFERENCE SIGNS LIST

10 INFORMATION PROCESSING DEVICE
110 LEARNING UNIT
120 INPUT/OUTPUT CONTROL UNIT
130 STORAGE UNIT

1. An information processing device, comprising:
a learning unit that optimizes parameters that determine a dynamic range by an error back propagation and a stochastic gradient descent in a quantization function of a neural network in which the parameters that determine the dynamic range are arguments.

2. The information processing device according to claim 1, wherein
the parameters that determine the dynamic range include at least a bit length at a time of quantization.

3. The information processing device according to claim 2, wherein
the parameters that determine the dynamic range include an upper limit value or a lower limit value at a time of power quantization.

4. The information processing device according to claim 2, wherein
the parameters that determine the dynamic range include a step size at a time of linear quantization.

5. The information processing device according to claim 1, wherein
the learning unit optimizes, for each layer, the parameters that determine the dynamic range.

6. The information processing device according to claim 1, wherein
the learning unit optimizes, for a plurality of layers in common, the parameters that determine the dynamic range.

7. The information processing device according to claim 1, wherein
the learning unit optimizes, for an entire neural network in common, the parameters that determine the dynamic range.

8. The information processing device according to claim 1, further comprising:
an input/output control unit that controls an interface that outputs the parameters that determine the dynamic range optimized by the learning unit.

9. The information processing device according to claim 8, wherein
the input/output control unit acquires an initial value input by a user via the interface, and outputs the parameters that determine the dynamic range optimized on a basis of the initial value.

10. The information processing device according to claim 9, wherein
the input/output control unit acquires an initial value of a bit length input by the user via the interface, and outputs a bit length at a time of quantization optimized on a basis of the initial value of the bit length.

11. The information processing device according to claim 8, wherein
the input/output control unit acquires setting related to quantization input by a user via the interface, and outputs the parameters that determine the dynamic range optimized on a basis of the setting.

12. The information processing device according to claim 11, wherein
setting related to the quantization includes setting of whether or not to permit a quantized value to be a negative value.

13. The information processing device according to claim 11, wherein
setting related to the quantization includes setting of whether or not to permit a quantized value to be 0.

14. The information processing device according to claim 1, wherein
the quantization function is used for quantization of at least any of a weight, a bias or an intermediate value.

15. An information processing method, by a processor, comprising:
optimizing parameters that determine a dynamic range by an error back propagation and a stochastic gradient descent in a quantization function of a neural network in which the parameters that determine the dynamic range are arguments.
